(19) United States
(12) Patent Application Publication
(10) Pub. No.: US 2004/0072666 A1
(43) Pub. Date: Apr. 15, 2004

(54) Centrifuge having an emergency off system

(76) Inventor: Reinhard Moss, Ennigerloh (DE)

Correspondence Address: BARNES & THORNBURG, 750-17TH STREET NW, SUITE 900, WASHINGTON, DC, 20006, US

(21) Appl. No.: 10/673,233

(22) Filed: Sep. 30, 2003

(30) Foreign Application Priority Data
Oct. 11, 2002 (DE) 102 47 646.2-23

(51) Int. Cl. B04B 11/04

(52) U.S. Cl. 494/37; 494/5; 494/30

(57) ABSTRACT

A centrifuge, particularly a separator (1) with a vertical axis of rotation, having a centrifugal drum (2) which is equipped with a feeding tube (4) for material to be centrifuged as well as with outlet nozzles, an emergency off system being connected in front of the centrifugal drum (2), is characterized in that the emergency off system has a feeding system (17) for particles, particularly balls (16), into the centrifugal drum. In the case of a method of implementing an emergency off function of a centrifuge, balls (16), which plug the outlet nozzles, are correspondingly guided into the centrifugal drum (2) in an emergency off case.

The invention relates to a centrifuge, particularly a separator with a vertical axis of rotation, having a centrifugal drum, which is equipped with a feeding tube for material to be centrifuged as well as with outlet nozzles, an emergency off system being connected in front of the centrifugal drum. The invention also relates to a method of implementing an emergency off function of a centrifuge.

A centrifuge according to the above-mentioned type in the form of a separator with a vertical axis of rotation according to the preamble of claim 1 is known from German Patent Document DE 651 907 C.

German Patent Document DE 33 20 152, which is of a different type, shows a return valve with a ball arranged on a spring.

From German Patent Document DE 2 046 274 A, it is also known to close outlet openings of a centrifuge in the event of an emergency in the case of a major unbalanced mass.

For example, as a result of the occurrence of imbalances, it may be necessary to manually or automatically switch off a separator. Imbalances may be caused by a one-sided clogging of individual nozzles because the solids are no longer discharged in these areas. For example, a centrifuge is known which is constructed as a separator with a vertical axis of rotation and has a nozzle drum above which, for the implementation of an emergency-off system, an emergency off container is arranged which leads into the inlet of the separator and has the purpose of receiving a liquid, such as water.

In an emergency off case, the product feeding is stopped as a rule, and a switch-over takes place to water, in order to avoid losses.

Since the centrifugal drum may continue to rotate for minutes until it stops, after the activation of the emergency off function, liquid will be directed into the centrifugal drum until the latter comes to a stop, so that the negative effect of the unbalanced mass will not be increased by the draining-off of the nozzle drum (loss of the balancing liquid). The emergency off container therefore has to take in, for example, up to 10 m3 of water.

The relatively large space requirement of the emergency off container and its relatively high costs are a disadvantage in this case.

It is therefore an object of the invention to reduce these problems.

With respect to the centrifuge, the invention achieves this task by means of the object of claim 1 and, with respect to the method, by means of the object of claim 12.

Advantageous further developments are contained in the subclaims.

According to the invention, the emergency off system has a feeding system for particles, particularly balls, into the centrifugal drum. The invention also provides a method for implementing an emergency off function of a centrifuge by which particles, particularly balls, are guided into the centrifugal drum, which balls plug the outlet nozzles.

By means of the solid particles, particularly balls, in the emergency off case, the drum is stopped or “brought to a stop” within a short time without water or only with the addition of a little more water. Since the centrifugal drum can no longer drain completely, the risk of “rising imbalance forces” is reduced, which risk occurs when, during an imbalance, the centrifugal drum is emptied at a high rotational speed, because this increases the influence of the imbalance on the centrifugal drum since the balancing effect of the product or of the water is eliminated.

Particularly preferably, the solids discharge is equipped with outlet nozzles, and the balls have a larger diameter than the outlet nozzles.

Particularly according to this variant, the container with the balls can be dimensioned to be much smaller and is therefore more cost-effective than the water tank of the prior art because only as many balls are required as are necessary for plugging the outlet nozzles.

Although the centrifugal drum has to be opened after an activation of the emergency off system in order to remove the particles, particularly the balls, this opening generally is required anyhow in an emergency off case because of the unbalanced masses, so that, as a rule, no additional expenditures occur as a result of the removal of the balls from the centrifugal drum.

It was found to be advantageous for the particles, particularly balls, to have a diameter at least 5% larger than the outlet nozzles.

The particles, particularly balls, may consist of rubber or a plastic material or advantageously, for avoiding problems with respect to hygiene or the like, of dried or possibly pressed solids of the material to be processed.

The particles are preferably introduced under pressure into the centrifugal drum.

In the following, the invention will be described in detail by means of embodiments with reference to the drawing.

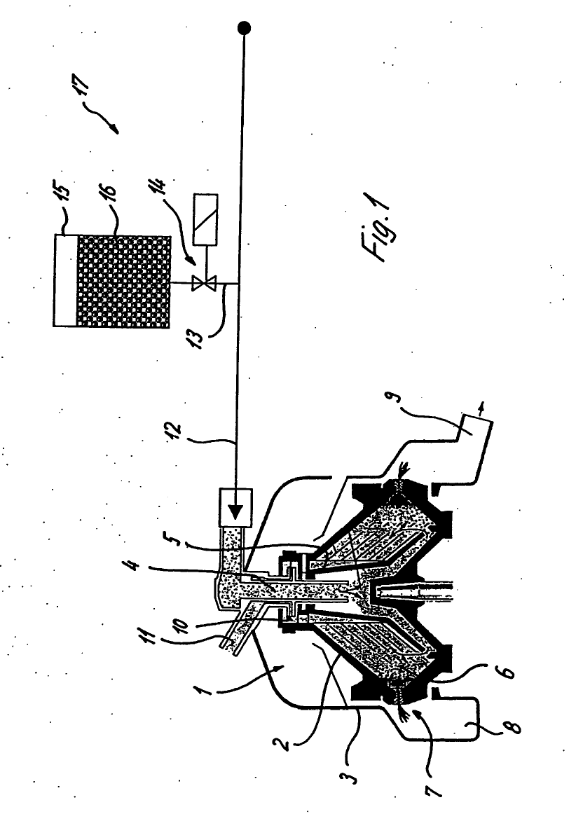

FIG. 1 is a view of a separator according to the invention.

FIG. 1 illustrates a centrifuge which is constructed as a separator 1 with a vertical axis of rotation and which has a centrifugal drum 2—nozzle drum—which is surrounded by a hood 3.

Here, the centrifugal drum 2 has a feeding tube 4 for material to be centrifuged, which feeding tube 4 extends from above into the centrifugal drum 2 and leads into a distributor 5 from which the material to be centrifuged is guided into the centrifuge chamber 6 of the centrifugal drum 2. As an alternative, a feeding from below by means of the spindle into a distributor is also conceivable. In this case, the spindle acts as an inflow tube.

For discharging the material from the nozzle drum 2, at least one solids discharge for a more solid phase and at least one liquid discharge for a more liquid phase is provided. The solids discharge is implemented by the outlet nozzles 7 which are distributed on the circumference of the centrifugal drum 2 (or which may, for example, be constructed in a tubular slide valve) and through which the solids are guided into a solids catching device 8 and are guided from there into a discharge duct 9. In contrast, the liquid outlet is provided here with a rotary-cut disk which leads into a discharge 11.

A feed line 12 is connected in front of the feeding tube 4 and is arranged above the centrifugal drum 2. A branch pipe 13, which is equipped with a valve 14—the valve 14 is therefore connected in front of the feeding tube 4—leads into the feed line 12, which valve 14, at its end facing away from the feed line 13, leads into a container 15 for receiving particles, particularly balls 16, for example, made of rubber, which balls 16 have a larger diameter than the outlet nozzles 7. In this manner, an emergency off system in the form of a feeding system 17 for particles into the centrifugal drum 2 is implemented without any major constructive expenditures.

In the event of an emergency—that is, when an “emergency off signal” is present or during a manual emergency operation, for example, because of a recorded imbalance of the centrifugal drum 2—the valve 14 is opened up, so that the balls 16 (for example, by means of water pressure or by means of a piston) are pressed out or washed out of the container 15 through the branch pipe 13 with the valve 14—for example, a normally open valve—into the feed line 12 and, from there, into the feeding tube 4 until they finally enter through the distributor 5 into the centrifuging chamber, where they are centrifuged toward the outside because of their appropriately defined “greater” specific weight, so that they are deposited in front of the outlet nozzles 7 and plug the latter. As a result, the centrifugal drum 2 can stop or “come to a stop” without water or with the addition of only a little water. A prestressed container 15 (for example, by means of a compressed-air-actuated piston or the like) is also conceivable. Here, it is particularly advantageous that the functioning is also maintained in the event of a power failure. The balls can also float in the container in a carrier liquid, such as water, in order to facilitate their feeding into the separator.

Since in this condition, the centrifugal drum 2 can no longer drain off completely, the risk of “rising imbalance forces” is reduced which occurs when during an imbalance, the centrifugal drum 2 is drained at a high rotational speed, because this intensifies the effect of the imbalance on the centrifugal drum.

The container 15 with the balls 16 can be dimensioned to be much smaller and is therefore more cost-effective than the water tank of the prior art.

### REFERENCE NUMBERS

Separator 1

centrifugal drum 2

hood 3

feeding tube 4

distributor 5

centrifugal chamber 6

outlet nozzles 7

solids catching device 8

discharge duct 9

rotary-cut disk 10

discharge 11

feed line 12

branch pipe 13

valve 14

container 15

balls 16

feeding system 17

1. Centrifuge, particularly a separator (1) with a vertical axis of rotation, having a centrifugal drum (2)—a nozzle drum—which is equipped with a feeding tube (4) for material to be centrifuged as well as with outlet nozzles (8), an emergency off system being connected in front of the centrifugal drum (2), characterized in that the emergency off system has a feeding system (17) for particles, particularly balls (16), into the centrifugal drum.

2. Centrifuge according to claim 1, characterized in that the balls (16) have a larger diameter than the outlet nozzles (7).

3. Centrifuge according to claim 1, characterized in that the balls (16) have a diameter which is by at least 5% larger than the outlet nozzles (7).

4. Centrifuge according to claim 1 or 2, characterized in that the particles, particularly balls (16), have a greater specific weight than the liquid phase(s) of the material to be processed.

5. Centrifuge according to one of the preceding claims, characterized in that the particles, particularly balls (16), consist of rubber or plastic material.

6. Centrifuge according to one of the preceding claims, characterized in that the particles, particularly balls (16), consist of dried solids.

7. Centrifuge according to one of the preceding claims, characterized in that the feeding system has an emergency off container (15) for receiving the balls (16).

8. Centrifuge according to one of the preceding claims, characterized in that the particles, particularly balls, in the emergency off container are received in a carrier liquid.

9. Centrifuge according to one of the preceding claims, characterized in that the emergency off container (15) is constructed as a prestressed container.

10. Centrifuge according to one of the preceding claims, characterized in that a valve (14) is connected in front of the feeding tube (4).

11. Centrifuge according to one of the preceding claims, characterized in that the valve (14) is a normally open valve.

12. Method of implementing an emergency off function of a centrifuge, particularly according to one of the preceding claims, characterized in that particles, particularly balls (16), which plug the outlet nozzles (7), are guided into the centrifugal drum in an emergency off case.

13. Method according to claim 12, characterized in that the particles are introduced under pressure into the centrifugal drum (2).
